(19) United States
(12) Patent Application Publication
(10) Pub. No.: US 2025/0182518 A1
(43) Pub. Date: Jun. 5, 2025

(54) AQUATIC FRY AI COUNTING SYSTEM AND METHOD

(71) Applicants: Yu-Noah Chu, Taipei City (TW); Wei-Chiang Sun, Kaohsiung City (TW)

(72) Inventors: Yu-Noah Chu, Taipei City (TW); Wei-Chiang Sun, Kaohsiung (TW)

(21) Appl. No.: 18/942,855

(22) Filed: Nov. 11, 2024

(30) Foreign Application Priority Data
Dec. 1, 2023 (TW) 112146918

(51) Int. Cl. G06V 40/10; G06V 10/145; G06V 10/70; G06V 20/05

(52) U.S. Cl. CPC G06V 40/10; G06V 10/87; G06V 20/05; G06V 10/145

(57) ABSTRACT

This invention utilizes a combination of a mobile photography device, a transparent fry containment basin, a light source, and integrates an AI database with data training to achieve rapid and accurate counting of aquatic fry. The operational process involves users capturing fry through the mobile photography device, with the captured images transmitted to the backend for artificial intelligence computation. The real-time results are then sent back to the users. In comparison to traditional manual counting, this system enhances efficiency, reduces labor costs, and overcomes issues associated with the bulkiness, inconvenience, and high costs of traditional fry counting equipment in the aquaculture industry. This technological innovation provides a more convenient and cost-effective solution for fry counting, making the process more intelligent and accessible.

### BACKGROUND OF THE INVENTION

### 1. Field of the Invention

The present invention relates to an aquatic fry AI counting system and method for use in the aquaculture industry, particularly a system and method that combines a mobile photography device, a containment basin, and artificial intelligence computation.

### 2. Description of the Prior Art

Fish fry counting songs, unique to Taiwan's traditional fishing culture, are a type of work song used to assist fishermen in accurately counting fish quantity in the fish fry trade. Often sung by specialized fish fry counters with unique melodies and rhythms, these songs not only ensure accurate counting but also add a unique cultural flavor to the labor.

However, with technological advancements and the popularization of artificially propagated aquatic fry, the traditional fish fry counting song has gradually diminished in the modern fishing industry. Despite these technological breakthroughs, human counting of aquatic fry remains important in the aquatic fry trade. This is mainly because aquaculture farms, both domestic and international, continue to use this method. However, due to the aging population, this task is predominantly undertaken by middle-aged and elderly individuals, requiring a certain degree of physical strength and skill. In traditional trading of aquatic fry, buyers often inquire about the availability of sufficient quantities of aquatic fry. In response, sellers must promptly mobilize their staff to conduct real-time inventory checks to report the exact numbers of the aquatic fry. Additionally, when shipping products, sellers need to count and pack the aquatic fry according to the buyer's requirements. Finally, buyers must recount the quantity of the aquatic fry upon receipt to ensure accuracy. This process necessitates at least three manual counts, making it time-consuming and labor-intensive.

With the advancement of technology, more and more innovative methods for counting aquatic fry have emerged. The current mainstream method involves guiding the aquatic fry through a water slide, followed by the use of an image recognition system for counting. However, the hardware of the image recognition system is quite bulky and not suitable for on-site operations in aquaculture environments. In addition to being heavy and cumbersome, these systems also require a power outlet and a computer for operation, failing to meet the practical needs of the aquaculture industry for portability, mobility, and immediate operability. Additionally, when changing the type of aquatic fry, it is necessary to adjust the image recognition software parameters via a computer for accurate identification. As the appearance of aquatic fry varies from one species to another, each species has different levels of transparency and patterns. Particularly for smaller-sized species, the rate of damage while passing through the water slide is quite high. Although technological advancements in counting aquatic fry have improved efficiency, there is still a need for more streamlined, portable and user-friendly systems to the realities of the aquaculture field.

Another method of counting aquatic fry involves using a computer combined with a camera obscura. This approach employs high-performance photographic equipment in conjunction with a computer, requiring initial setup of the photographic equipment's parameters via the computer. Before operations begin, a batch of aquatic fry must be manually counted for reference, followed by multiple system tests to ensure accuracy. After several adjustments of the parameters for precision, the formal counting process can start. However, the large size of this camera obscura is not well-suited for practical operations in the aquaculture field. Additionally, the system operation typically requires a power outlet and computer control. The equipment's lack of waterproofing also poses challenges in meeting the specific requirements of the aquaculture environment. When dealing with various types of aquatic fry, each operation necessitates manual counting and numerous parameter adjustments, making the process inefficient and time-consuming. This operational mode, along with the high loss rate of aquatic fry and the need for professional adjustments, limits its accessibility to general aquaculture farmers and contributes to its limited adoption in the aquaculture industry.

From the above description, it is evident that manual counting remains crucial in the modern trade of aquatic fry. This labor-intensive method relies heavily on an aging workforce of middle-aged and elderly individuals, demanding significant human resources. Technological approaches, such as systems combining water slides with image recognition, face challenges due to their bulky and heavy hardware, making them impractical for on-site operations in the aquaculture field. Additionally, these systems require a power outlet, which often doesn't align with the practicalities of such sites. They are also sensitive to different types of aquatic fry, requiring frequent parameter adjustments and leading to a high loss rate of aquatic fry. Moreover, the method of combining computers with camera obscura is impractical for aquaculture operations due to its large size and heavy weight. This approach not only requires a power outlet but also involves complex operations and is difficult to waterproof. The high costs of the photographic equipment in the camera obscura further add to its impracticality. Manually counting a batch of aquatic fry and making multiple adjustments to the parameters render this mode of operation inefficient and not timely for the aquaculture industry. Considering factors like the transparent body color of the aquatic fry, their overlapping positions, and continuous movement, these methods fail to meet the needs of aquaculture farmers both domestically and internationally. Consequently, manual labor remains the predominant method used.

### SUMMARY OF THE INVENTION

To address the aforementioned problems, the present invention provides an aquatic fry AI counting system for counting various types of aquatic fry, comprising: a mobile photography device, wherein the mobile photography device comprises at least one camera module, a wireless transmission unit, and a display screen; a containment basin, wherein the containment basin is used for holding the target aquatic fry to be counted; and an AI database, wherein the AI database is pre-trained with a large number of photos of various types of aquatic fry for counting, forming a plurality of training models for multiple types of aquatic fry, and is capable of transmitting data on the quantity of the aquatic fry to the mobile photography device; wherein the containment basin contains the aquatic fry to be counted, and a user can control the camera module through the mobile photography device to take a photo of the containment basin, then transmit the photo to the AI database through the wireless transmission unit of the mobile photography device for counting computation of the aquatic fry; wherein the data of the quantity of the aquatic fry is generated by using the corresponding training model from the photo, and the AI database can automatically send the data back to the mobile photography device through the wireless transmission unit and display the data on the display screen; and wherein the AI database can cumulatively tally the quantity of the aquatic fry across multiple photos.

The AI database utilizes computer vision AI recognition to analyze and interpret image data. Through deep learning models, it can learn visual patterns and accurately identify features such as the contours and surface textures of different fish species, requiring only a small number of photos and a few hours of training. This approach effectively avoids misidentifying impurities or algae as fish, achieving an accuracy rate of at least 93%.

Regarding the aquatic fry AI counting method for counting various types of aquatic fry according to the present invention, the aquatic fry AI counting method comprises the following steps:
step 1: placing the aquatic fry to be counted in a containment basin;
step 2: taking a photo of the aquatic fry contained in the containment basin using a camera module of a mobile photography device;
step 3: uploading the photo via a wireless transmission unit of the mobile photography device to an AI database, wherein the AI database is pre-trained through a large number of various types of aquatic fry photos for counting, forming a plurality of training models for multiple types of aquatic fry, and then selecting the training model corresponding to the type of the aquatic fry being counted to process the photo and generate a data on a quantity of the aquatic fry in the photo; and
step 4: sending the data back to the mobile photography device by the AI database and displaying the data on the quantity of the aquatic fry in the photo on a display screen of the mobile photography device;
wherein the AI database can rapidly count the quantity of the aquatic fry in the photo, and by repeating the aforementioned four steps, the AI database can cumulatively tally the quantity of the aquatic fry across multiple photos and display a total number of the aquatic fry on the display screen of the mobile photography device.

The main technical method of the present invention involves the use of a mobile photography device, wherein the mobile photography device can be a smartphone, tablet, or smart camera. Users are not required to purchase any additional expensive or bulky equipment. They can place the aquatic fry to be counted in a containment basin and take photos of the aquatic fry. These photos are then wirelessly uploaded to an AI database using WIFI, 5G, or 4G mobile networks. The AI database is also capable of instantly transmitting the computation results back to the mobile photography device. By repeating the aforementioned steps, the quantity of aquatic fry can be rapidly accumulated. This method significantly shortens the time needed for traditional manual counting by more than tenfold. Additionally, the manufacturing cost of the hardware is lower, eliminating the need for expensive photographic lenses and large-scale equipment such as an aquatic fry counter with a camera obscura or an aquatic fry counter with water slide image recognition.

Another technical aspect of the present invention is that the mobile photography device is preloaded with an application program capable of communicating with the AI database. The AI database can complete a training model for each type of aquatic fry within three days. The user can directly take photos, upload them, and select the corresponding training model through the application program to count the number of aquatic fry in the photos. Furthermore, the application program enables users to cumulatively tally the aquatic fry counts from multiple photos, facilitating quick inventory and packaging in a short period, thereby reducing aquatic fry mortality.

In another technical aspect, the present invention further comprises a light source, wherein the light source is provided at a suitable place in the containment basin and the containment basin is made of a light-transmitting material. The light source can be provided at the bottom or side of the containment basin. In a preferred embodiment, the light source is placed at the bottom of the containment basin. The containment basin is designed using translucent acrylic, and a backlight box is selected as the light source. Firstly, the backlight box utilizes a bottom light source to effectively reduce reflections on the water surface inside the containment basin, regardless of whether the reflection is from sunlight or other light sources, thereby creating a relatively smooth environment free from light interference. This helps to ensure that during the process of photographing the aquatic fry, the subjects can be captured in clear and authentic images, avoiding the effects of light reflection.

Secondly, the use of a backlight-style light source offers significant advantages. This design guides the mobile phone, when used as a mobile photography device, to adjust the camera parameters, especially the aperture and shutter speed during picture-taking. When the mobile phone is in automatic mode and facing the direction of the light source, the aperture will automatically narrow, limiting the light entering the lens and preventing overexposure in the photos. At the same time, the shutter speed will increase, shortening the exposure time and effectively preventing overexposure. Such a design helps ensure that during the photography process, the captured subjects are accurately presented. This avoids motion blur caused by the movement of live aquatic fry and interference from water ripples on computer analysis, thereby enhancing the accuracy of the images. In addition to handheld photography, the containment basin and the light source can be set up on a trolley frame. Additionally, a mobile phone holder can be mounted on this trolley frame, facilitating convenient photography operations for the user.

Furthermore, the design of the containment basin in the present invention is versatile and can be either box-shaped or bag-shaped. In another preferred embodiment, the containment basin can also be used to package the aquatic fry. After packaging is complete, photos can be taken and then transmitted to the AI database for counting, thereby accelerating the packaging process.

The containment basin of the present invention can also be box-shaped, allowing it to float on water. The backlight box may feature waterproof properties, with the preferred implementation being a waterproof backlight panel. This makes it convenient for users to operate on water or at the water's edge on land. In areas without a power supply, power can be provided using a mobile power supply, which can be either built into the light source or be an external mobile power supply.

Finally, the degree of recognition of certain special aquatic fry can be enhanced by using lens filters, adjusting the light source's color temperature and lighting color, or modifying settings in the photography software. The most convenient method to increase photo recognition involves using a colored bag, either placed over the exterior of the containment basin or encasing both the basin and the light source. After the colored bag is in place, the aquatic fry is poured in to achieve optimal aquatic fry recognition in the photographs. Additionally, the colored bag serves to protect the containment basin and the light source from dirt and damage.

### BRIEF DESCRIPTION OF THE DRAWINGS

FIG. 1 is a schematic diagram of the system according to the present invention;

FIG. 2 is a flowchart of the present invention;

FIG. 3 is a schematic diagram of Embodiment 1 of the present invention; and

FIG. 4 is a schematic diagram of Embodiment 2 of the present invention.

### DETAILED DESCRIPTION OF THE PREFERRED EMBODIMENTS

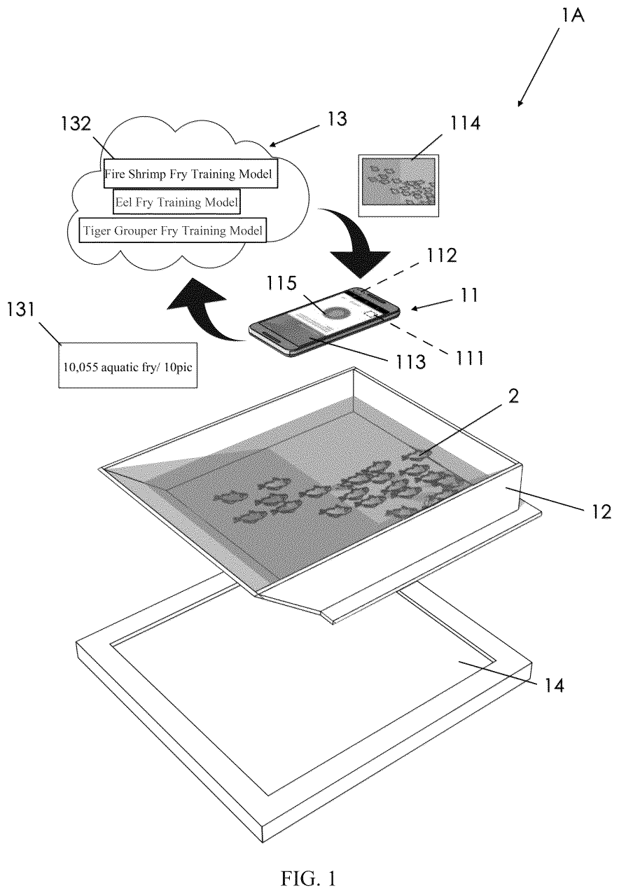

Please refer to FIG. 1, which is a schematic diagram of the system according to the present invention. FIG. 1 discloses an aquatic fry AI counting system 1A for counting various types of aquatic fry 2, comprising: a mobile photography device 11, wherein the mobile photography device 11 comprises at least one camera module 111, a wireless transmission unit 112, and a display screen 113; a containment basin 12, wherein the containment basin 12 is used for holding the aquatic fry 2 to be counted; and an AI database 13, wherein the AI database 13 is pre-trained with a large number of various types of aquatic fry photos for counting, forming a plurality of training models 132 for multiple types of aquatic fry, and is capable of transmitting a data on a quantity of the aquatic fry to the mobile photography device 11; wherein the containment basin 12 contains the aquatic fry 2 to be counted, and a user can control the camera module 111 through the mobile photography device 11 to take a photo 114 of the containment basin 12, then transmit the photo 114 to the AI database 13 through the wireless transmission unit 112 of the mobile photography device 11 for counting computation of the aquatic fry; wherein the data of the quantity of the aquatic fry is generated by using the corresponding training model 132 from the photo 114, and the AI database 13 can automatically send the data 131 back to the mobile photography device 11 through the wireless transmission unit 112 and display the data 131 on the display screen 113; and wherein the AI database 13 can cumulatively tally the quantity of the aquatic fry 2 from multiple photos 114.

The diagram also discloses that the mobile photography device 11 is equipped with an application program 115 capable of communicating with the AI database 13. The application program 115 is configured to perform photography, upload photos, and display the quantity of the aquatic fry. In addition, the application program can cumulatively tally the quantity of the aquatic fry across multiple photos.

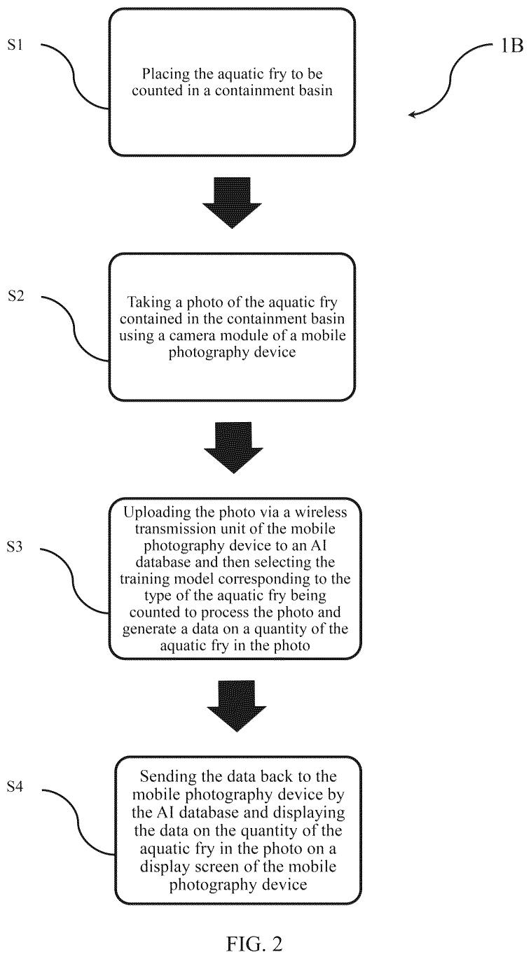

Please refer to both FIG. 1 and FIG. 2. FIG. 2 illustrates an aquatic fry AI counting method 1B for counting various types of aquatic fry. The method comprises step 1 (S1), which involves placing the aquatic fry 2 to be counted into a containment basin 12. Before commencing the counting process, certain preparatory work is necessary. The aquatic fry to be counted, whether they are fish fry or shrimp fry (aquatic fry 2), are placed in the containment basin 12. The use of light-transmitting materials for the containment basin 12 ensures an optimal environment for photography.

In accordance with environmental requirements, the aquatic fry AI counting system 1A further comprises a light source 14. This light source 14 is positioned at an appropriate location in the containment basin 12, as illustrated in FIG. 1. The light source 14 is a waterproof backlight panel, placed at the bottom of the containment basin 12. The light from the light source 14 can penetrate through the containment basin 12, effectively reducing reflections on the water surface caused by sunlight or other light sources. This creates a relatively smooth environment, free from light interference, which helps ensure that during photography of the aquatic fry, the captured images are clear and accurate by avoiding the effects of light reflection.

Regarding step 2 (S2): “Taking a photo 114 of the aquatic fry 2 contained in the containment basin 12 using a mobile photography device 111”, a user can control the camera module 111 through the mobile photography device 11 to take a photo 114 of the aquatic fry within the containment basin 12. The importance of this step is to provide high-quality imagery for the AI database 13, which utilizes the corresponding training model 132 specifically for the aquatic fry 2 within the containment basin 12, facilitating analysis and counting. During the photography process, the user can instantly assess the quality of photo 114 via the display screen 113 to ensure it fulfills the necessary counting requirements.

Regarding step 3 (S3), “Uploading the photo 114 via a wireless transmission unit 112 of the mobile photography device 11 to an AI database 13, wherein the AI database 13 is pre-trained with a large number of various types of aquatic fry photos for counting, forming a plurality of training models 132 for multiple types of aquatic fry, and then selecting the training model 132 corresponding to the type of the aquatic fry 2 being counted to process the photo 114 and generate a data 131 on a quantity of the aquatic fry 2 in the photo 114”, this step is a crucial part of the system, determining the accuracy and efficiency of the counting process. The AI database 13 undergoes extensive pre-training with a large number of various types of aquatic fry photos. The AI database 13 can complete a training model 132 for each type of aquatic fry within three days and can rapidly count the quantity of the corresponding type of aquatic fry 2 in the photo.

Regarding step 4 (S4), “Sending the data 131 on the quantity of the aquatic fry 2 back to the mobile photography device 11 by the AI database 13 and displaying the data 131 on the quantity of the aquatic fry 2 in the photo 114 on a display screen 113 of the mobile photography device 11”, once the counting is complete, the AI database 13 transmits the data 131 of the counting results back to the mobile photography device 11 via the wireless transmission unit 112. This step achieves real-time feedback for the aquatic fry AI counting system 1A according to the present invention, allowing the user to promptly view and confirm the counting results. The display screen 113 will display the quantity of the aquatic fry 2 counted.

By repeating the aforementioned four steps, the AI database 13 can cumulatively tally the quantity of the aquatic fry 2 across multiple photos 114. The aquatic fry AI counting method 1B according to the present invention supports ongoing photography and counting, enabling accumulation of the count of aquatic fry 2 across numerous photos 114 within a short time period. This provides the user with more comprehensive data while also ensuring the stability of the counting process.

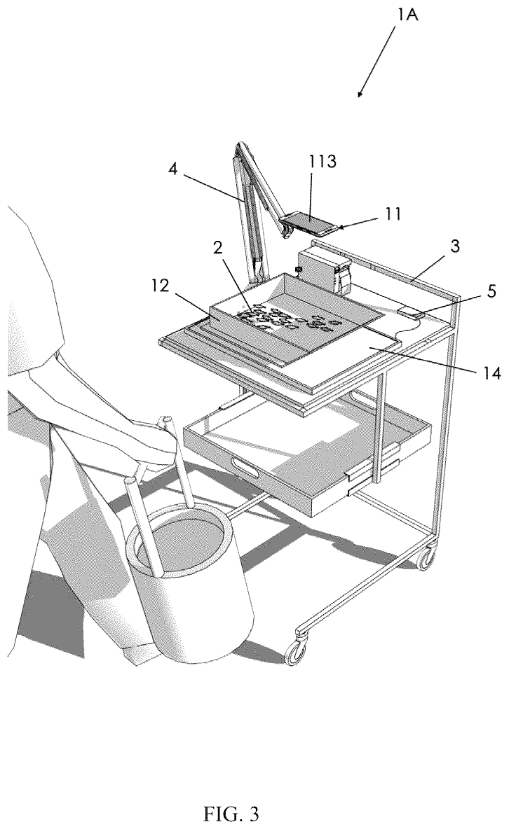

Please refer to FIG. 3, which illustrates Embodiment 1 of the present invention. In addition to handheld photography for the mobile photography device 11, the containment basin 12 and the light source 14 can be set up on a trolley frame 3, along with a holder 4 provided on the trolley frame 3. The holder can be used to support and mount the mobile photography device 11, facilitating convenient photography operations for the user. Given that the user works in aquaculture fields or near the water's edge, the light source 14 can be a backlight box. The mobile photography device 11 can be a smartphone or tablet with photographic capabilities, or a smart digital camera, significantly reducing the hardware size and weight and making it more portable. Moreover, the flat backlight is easily manufactured to be waterproof. The use of a bottom-light source from the backlight box effectively reduces reflections on the water surface in the containment basin 12, regardless of whether the reflection is from sunlight or other light sources. This creates a relatively smooth environment free from light interference, which helps ensure that during the process of photographing the aquatic fry, the subjects can be captured in clear and authentic images, avoiding the effects of light reflection. Compared to known fry-counting products, this results in cost savings, reduced size and weight, and more convenient and flexible use. Additionally, as shown in the figure, the light source 14 can be powered by a mobile power supply 5, where the mobile power supply 5 is an external type.

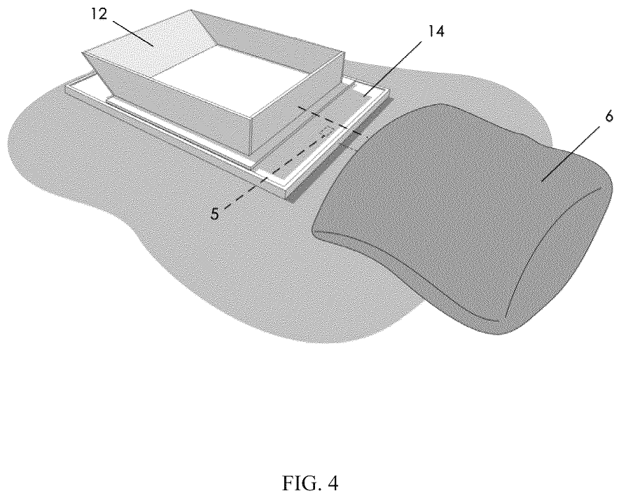

Finally, please refer to FIG. 4, which is a schematic diagram of Embodiment 2 of the present invention. FIG. 4 shows that the containment basin 12 of the present invention is box-shaped, facilitating operations on water surfaces and meeting the needs of aquaculture environments. Currently, the mobile photography device 11, such as smartphones, generally has waterproof capabilities. A light source 14 is provided at the bottom of the containment basin 12. In the design, the containment basin 12 is made of a translucent acrylic material, and a waterproof backlight box is selected as the light source 14. The waterproof backlight box can internally incorporate a mobile power supply 5, which could be a standard battery or a rechargeable lithium battery. The present invention addresses the known issues of bulkiness, high cost, inconvenience in portability, and complexity in operation associated with traditional fry counting systems. By using a mobile photography device 11 in conjunction with an application program 115, the operation becomes simpler and more intuitive. It also resolves the issue of data uploading, typically a challenge in areas near water or aquaculture fields that lack network coverage. The use of a mobile power supply 5 overcomes the need for additional electricity supplies in the working area, representing a revolutionary digital transformation in the industry.

To improve recognition of uniquely colored aquatic fry in photos, the photo clarity can be enhanced through the use of lens filters, adjustments to the color temperature and lighting color of the light source, or by making modifications in the photography software. As illustrated in FIG. 4, the most convenient method involves using a colored bag 6. The colored bag 6 is placed over the exterior of the containment basin 12, or it can encase both the containment basin 12 and the light source 14. Once the colored bag 6 is in place, the aquatic fry 2 with unique colors are poured into the containment basin 12 to achieve optimal photo recognition. Additionally, the colored bag 6 serves to protect the containment basin 12 or the light source 14 from dirt and damage, which is particularly useful for operations in water or along the shore.

The above descriptions have comprehensively introduced the aquatic fry AI counting system and method according to the present invention. It should be emphasized that the above descriptions are made on embodiments of the present invention; however, the embodiments are not intended to limit the scope of the present invention, and all equivalent implementations or alterations within the spirit of the present invention still fall within the scope of the present invention.

What is claimed is:

1. An aquatic fry AI counting system for counting various types of aquatic fry, comprising:
a mobile photography device, wherein the mobile photography device comprises at least one camera module, a wireless transmission unit, and a display screen;
a containment basin, wherein the containment basin is used for holding the aquatic fry to be counted; and
an AI database, wherein the AI database is pre-trained with a large number of various types of aquatic fry photos for counting, forming a plurality of training models for multiple types of aquatic fry, and is capable of transmitting a data on a quantity of the aquatic fry to the mobile photography device;
wherein the containment basin contains the aquatic fry to be counted, and a user can control the camera module through the mobile photography device to take a photo of the containment basin, then transmit the photo to the AI database through the wireless transmission unit of the mobile photography device for counting computation of the aquatic fry;
wherein the data of the quantity of the aquatic fry is generated by using the corresponding training model from the photo, and the AI database can automatically send the data back to the mobile photography device through the wireless transmission unit and display the data on the display screen;
wherein the AI database can cumulatively tally the quantity of the aquatic fry from multiple photos.

2. The aquatic fry AI counting system of claim 1, wherein the containment basin is made of a light-transmitting material.

3. The aquatic fry AI counting system of claim 1, wherein the aquatic fry AI counting system further comprises a light source and the light source is provided at a suitable place in the containment basin.

4. The aquatic fry AI counting system of claim 1, wherein the mobile photography device is equipped with an application program capable of communicating with the AI database; the application program is configured to perform photography, upload photos, count the quantity of the aquatic fry in the photo, and cumulatively tally the quantity of the aquatic fry across multiple photos.

5. The aquatic fry AI counting system of claim 3, wherein the light source is electrically connected to a mobile power supply.

6. An aquatic fry AI counting method for counting various types of aquatic fry, comprising:
step 1: placing the aquatic fry to be counted in a containment basin;
step 2: taking a photo of the aquatic fry contained in the containment basin using a camera module of a mobile photography device;
step 3: uploading the photo via a wireless transmission unit of the mobile photography device to an AI database, wherein the AI database is pre-trained through a large number of various types of aquatic fry photos for counting, forming a plurality of training models for multiple types of aquatic fry, and then selecting the training model corresponding to the type of the aquatic fry being counted to process the photo and generate a data on a quantity of the aquatic fry in the photo; and
step 4: sending the data back to the mobile photography device by the AI database and displaying the data on the quantity of the aquatic fry in the photo on a display screen of the mobile photography device;
wherein the AI database can rapidly count the quantity of the aquatic fry in the photo, and by repeating the aforementioned four steps, the AI database can cumulatively tally the quantity of the aquatic fry across multiple photos and display a total number of the aquatic fry on the display screen of the mobile photography device.

7. The aquatic fry AI counting method of claim 6, wherein the containment basin is made of a light-transmitting material.

8. The aquatic fry AI counting method of claim 6, wherein said step 2 further comprises a light source and the light source is provided at a suitable place in the containment basin.

9. The aquatic fry AI counting method of claim 6, wherein the mobile photography device is preloaded with an application program capable of communicating with the AI database; the application program is configured to perform photography, upload photos, count the quantity of the aquatic fry in the photo, and cumulatively tally the quantity of the aquatic fry across multiple photos.

10. The aquatic fry AI counting method of claim 8, wherein the light source is electrically connected to a mobile power supply.
